(19) United States
(12) Patent Application Publication
(10) Pub. No.: US 2003/0019796 A1
(43) Pub. Date: Jan. 30, 2003

(54) Round object processor

(76) Inventor: William C. DeLong, Clinton, WI (US)

Correspondence Address: NIRO, SCAVONE, HALLER & NIRO, Suite 4600, 181 W. Madison Street, Chicago, IL, 60602, US

(21) Appl. No.: 09/907,543

(22) Filed: Jul. 16, 2001

(51) Int. Cl. B03D 1/00; B03B 5/60; B07C 9/00; B03B 5/64

(52) U.S. Cl. 209/162

(57) ABSTRACT

The present invention concerns a device for separating acceptable objects from unacceptable objects. The device includes a moving inclined conveyor having an upper edge and an opposingly located lower edge. Also provided are a plurality of collection cells, with each cell defined by a first wiper and an opposingly located second wiper. The cells are located along the conveyor. At least one feed is also associated with each of the cells, and the at least one feed is positioned to deposit objects on the conveyor at an upper edge near the first wiper. An acceptable object collector is associated with each of the cells. The acceptable object collector is positioned to retrieve objects which have moved downwardly along the conveyor from the feed. The second wiper is positioned to obstruct the movement of unacceptable objects which have moved along said conveyor and to urge unacceptable objects into at least one unacceptable object collector located on the lower edge of said conveyor.

### BACKGROUND OF THE INVENTION

The present invention relates to a method and device for processing generally round objects such as soybeans. More specifically, the present invention relates to a method and device which uses an inclined conveyor and a plurality of wipers to define a plurality of collection cells that separate and sort round acceptable objects such as soybeans from unacceptable non-round objects.

### SUMMARY OF THE INVENTION

Prior art processing devices typically use a single conveyor in association with a single feed to sort acceptable objects from unacceptable objects. While capable of performing processing, devices of this type and design have both processing and operational inefficiencies. For example, using a single motor to power a single conveyor results in higher energy and maintenance costs. Moreover, operating a single feed with a single conveyor creates processing inefficiencies by limiting the capacity of the device to the flow rate of the single feed.

The present invention provides a more efficient device and method to sort objects. The present invention provides a sorter having a conveyor which has a plurality of wipers located along its path of travel. The wipers define a plurality of collection cells with each cell being associated with at least one feeder or source of the objects to be sorted and two collectors; one for acceptable objects and one for unacceptable objects. Using multiple feeds and collectors on at least one conveyor creates, among other things, processing, maintenance and energy consumption efficiencies.

Consequently, one object of the present invention is to provide a device which uses a single motor and conveyor to receive objects to be processed from a plurality of feeds.

Another object of the present invention is to form a plurality of collection cells on a single conveyor.

Yet another object of the present invention is to provide a collection system having a plurality of conveyors having a plurality of collection cells.

Still another object of the invention is to provide a sorter that is more energy efficient and requires less maintenance.

Another object of the invention is to provide a device which has a higher processing capacity than known prior art devices.

### DESCRIPTION OF THE DRAWINGS

These and other features, objects and advantages of the present invention will become apparent from the following description and drawings wherein like reference numerals represent like elements in several views, and in which:

FIGS. 1-4 illustrate a prior art sorter.

FIG. 5 is a front perspective view of one embodiment of the present invention.

FIG. 6 illustrates acceptable objects.

FIG. 7 illustrates unacceptable objects.

FIG. 8 is a perspective view of a collection cell.

FIG. 9 is a partial top view of a second conveyor which may be used with the present invention illustrating how a plurality of cells may be formed along multiple conveyors in a single device.

### DESCRIPTION OF THE PREFERRED EMBODIMENT

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

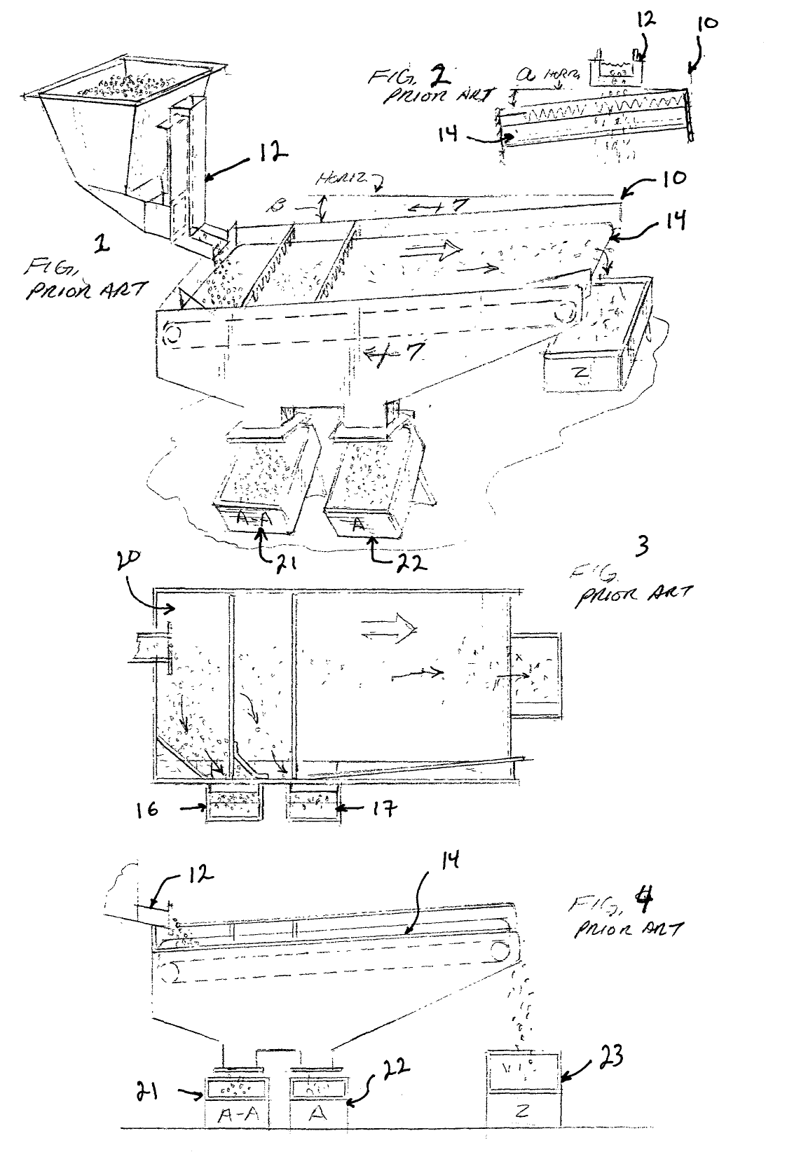

The prior art sorter shown in FIGS. 1-4 includes a sorter 10, a feeder 12, angled conveyor 14 as well as collectors 16 and 17. In use, the prior art operates by having feeder 12 deposit objects to be sorted on an upper end 20 of conveyor 14. Acceptable objects, which are round in shape as shown in FIG. 6, roll down the incline and are retrieved by collectors 16 and 17 and deposited into bins 21 and 22. Unacceptable objects, which are not round in shape as shown in FIG. 7, do not roll down the incline. Instead, as shown in FIG. 3, the objects travel along the conveyor until the objects fall off of the conveyor and land into bin 23. As shown, due to limitations in its design, the prior art uses a single power source to run a single conveyor with a single feed source to process objects. As was described above, this creates unwanted inefficiencies.

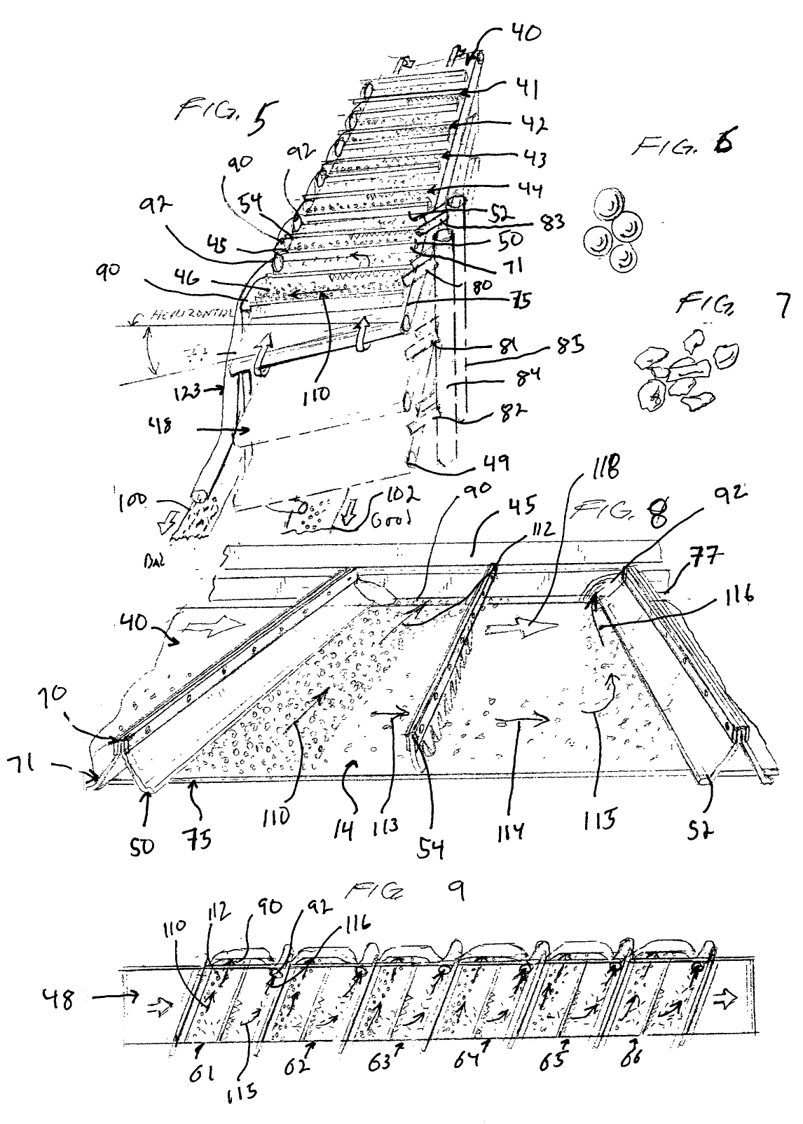

As shown in FIGS. 5, 8 and 9, the present invention overcomes the design limitations of the prior art by providing at least one conveyor 40 which works in association with a plurality of collection cells 41-46. As is also shown in FIG. 5, multiple conveyors 48 and 49 may also be provided with each conveyor having a plurality of cells thereon (not shown).A single drive source, such as an electric motor, may be used to operate the conveyors. The use of multiple conveyors with a single drive source eliminates the need to use and power multiple drive sources. It also eliminates the need to maintain multiple drive sources as well.

FIG. 8 illustrates a typical collection cell 45 which may be used with the present invention. Cell 45 is one of the plurality of cells which may be used with the present invention. Each cell may be defined by a first wiper 50 and second wiper 52. Each wiper may extend completely across conveyor 40 from upper edge 75 to lower edge 77. A comb 54 may also be provided between the wipers which assists in separating acceptable objects from unacceptable objects.

Where appropriate the first and second wipers may be made as a single or two-piece unit 70. As shown in FIG. 8, wiper unit 70 forms the second wiper 71 of cell 46 and the first wiper 50 of cell 45. In addition, the first cell located on the device may not need a first wiper.

Feeders 80-83 are also provided as shown in FIG. 5. While not illustrated, each collection cell has at least one individual feeder associated with it. The feeders may be in communication with tubes 84 and 85 which are in communication with a source of objects. Objects may be supplied to the feeders through gravity feeds, mechanical feeds, pneumatic feeds, and in other ways known to those of skill in the art. The feeders should be located at upper edge 75 near the first wiper so that the objects will be deposited near the upper corner of the cell near the first wiper.

As shown in FIGS. 5 and 9, each collection cell also has an acceptable object collector 90 and an unacceptable object collector 92. The collectors are arranged to transport the objects via gravity, pneumatically or mechanically to storage areas. As shown in FIG. 5, unacceptable objects may be transferred to conveyor 100 by tube or channel 123 for further processing. Likewise, acceptable objects may be transferred by tube or channel to conveyor 102 for further processing.

As shown in FIGS. 5, 8 and 9, the present invention works by using a feeder such as feeder 83 to place objects onto conveyor 40 at the upper edge 75 near a first wiper. The first wiper is arranged to prevent objects from entering an adjoining cell. Once on the conveyor, the conveyor's path of travel along with the incline causes acceptable objects, which are generally round in shape as shown in FIG. 6, to roll down the conveyor where they are retrieved by an acceptable object collector. The device is designed to then convey the objects to the next step in the processing.

Unacceptable objects, which are flawed in shape, as well as debris such as dirt, rocks, sticks, stalks and the like, are irregularly shaped as shown in FIG. 7. As a result, unacceptable objects do not easily roll down the incline of the conveyor. Instead, they are transported by the conveyor toward the second wiper and away from the acceptable object collector. The second wiper collects the unacceptable objects, and through the action of the conveyor, the objects are urged into a second collector 92 which is a spaced distance apart from collector 90.

The arrows shown on FIG. 8 illustrate the general paths of travel of objects within a collection cell. Arrows 110 and 112 illustrate a typical path of travel of acceptable objects. As shown in FIGS. 5 and 8, collector 90 is positioned relative to feed 83 to receive objects which have traveled downwardly across conveyor 40. Unacceptable objects travel in the direction of conveyor 40 as indicated by arrow 118. As shown by arrows 113-116, unacceptable objects travel in the direction of the conveyor until their movement is obstructed by the second wiper 52. The objects are then urged into unacceptable object collector 92 for further processing.

As illustrated, each cell is of a similar construction. In addition, multiple conveyors having multiple cells may be provided as illustrated in FIGS. 5 and 9. When configured in this manner, tremendous processing efficiencies are achieved over the design of the prior art.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. A device for separating acceptable objects from unacceptable objects comprising:
a moving inclined conveyor having an upper edge and an opposingly located lower edge;
a plurality of collection cells, each cell defined by a first wiper and an opposingly located second wiper, said cells located along said conveyor;
at least one feed associated with each of said cells, said at least one feed positioned to deposit objects on said conveyor at said upper edge near said first wiper;
at least one acceptable object collector associated with each of said cells, said at least one acceptable object collector positioned to retrieve objects which have moved downwardly along said conveyor from said feed; and
said second wiper positioned to obstruct the movement of unacceptable objects which have moved along said conveyor and to urge unacceptable objects into at least one unacceptable object collector located on said lower edge of said conveyor.

2. The device of claim 1 wherein said wipers extend completely across said conveyor.

3. The device of claim 1 including a plurality of inclined conveyors with each of said conveyors having a plurality of collection cells.

4. The device of claim 1 wherein a conveyor receives objects collected from said acceptable object collector and a separate conveyor receives objects collected by said unacceptable object collector.

5. The device of claim 1 wherein at least one comb is disposed between said wipers.

6. The device of claim 1 wherein at least one of said first and second wipers is formed as a single unit.

7. The device of claim 1 wherein said acceptable object collector and said unacceptable object collector are located along said lower edge of said conveyor in a spaced-apart relationship within a collection cell.

8. The device of claim 3 wherein a single drive source runs said plurality of conveyors.

9. The device of claim 1 wherein said objects are soybeans.

10. A method of sorting soybeans comprising:
using a plurality of feeds to deposit soybeans into a plurality of collection cells located along an inclined conveyor;
depositing said soybeans on an upper end of said inclined conveyor so that acceptable soybeans will travel down said inclined conveyor into an acceptable object collector for further processing;
moving unacceptable soybeans along said conveyor until obstructed by a wiper; and using said wiper to urge unacceptable soybeans into an unacceptable object collector for further processing.
